(19) United States
(12) Patent Application Publication
(10) Pub. No.: US 2007/0064612 A1
(43) Pub. Date: Mar. 22, 2007

(54) Method and apparatus for selecting an optimal path from a path-starting node of a network to a path-ending node of the network

(75) Inventors: Frederick Armanino, San Antonio, TX (US); Jerold D. Osato, Pinole, CA (US); Teresa Lees, Sunnyvale, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/230,084

(22) Filed: Sep. 19, 2005

(51) Int. Cl. H04J 3/14

(52) U.S. Cl. 370/238; 370/252

(57) ABSTRACT

In accordance with one aspect of the present invention, a method provides a circuit from a first customer location to a second customer location. The method includes selecting a path-starting node from a network of nodes, and selecting a path-ending node from the network of nodes. The path-starting node is connectable to the first customer location, and the path-ending node is connectable to the second customer location. The method also includes selecting at least one subset of files from a database containing a set of files. Each file of the set of files contains segment data pertaining to a segment that connects a pair of nodes within the network. Each of the at least one subset contains data pertaining to a path from the path-starting node to the path-ending node. If more than one subset of files is selected, selecting an optimal path corresponding to an optimal subset of files.

### BACKGROUND OF THE INVENTION

1. Field of the Invention

The present invention relates to network management, and more specifically to determining an optimal path through a network.

2. Description of the Related Art

Many industries face a problem of finding an optimal path through a network of nodes. For example, telecommunications companies have a network of switching stations around the world, each of which is connected directly to a few others by a high-capacity telecommunications link such as a wireless link, a satellite link, a microwave link, or a fiberoptic cable link. Each such switching station can be considered a node, and each such link may have been a segment connecting adjacent nodes. By concatenating segments, paths through the network are constructed.

Whenever a customer has requests a custom circuit, for example, connecting a first customer site to a second customer site, the telecommunications company is faced with a challenge to find a path through its own network from a path-starting node near the first customer site to a path-ending node near the second customer site. The telecommunications company then needs to find a sequence of segments that collectively provide the custom circuit for the customer. If the network has a large number of nodes, then the network may have many possible routes through the network from the first customer site to the second customer site.

Of course, a typical telecommunications company has analyzed its own network thoroughly. Commonly, the telecommunications company constructs a PDAC table to help its employees understand the network. Since any node in the network may be a path-starting node and any node in the network may be a path-ending node, and since the network may provide many possible paths between any two nodes, the PDAC table may be extensive.

Throughout this description, various acronyms and other terms are used. All such terms that are not herein defined are to be understood with reference to a Trunk Inventory Record Keeping System (“TIRKS”), which is a Telcordia product, and with reference to Telcordia TIRKS Format Field Directory, volumes 1-7, which have a reference number Telcordia Technologies Practice BR 756-551-790 Issue 59, release 20.2, dated November 2004, and which are hereby incorporated by reference in their entirety.

The PDAC table, which is part of the Multiple Network Segment Storage Structure (MNSS), may be understood as a spreadsheet having rows and columns. Each row of the spreadsheet describes a different path through the network. If any two nodes can be connected via a large number of paths, then each of the large number of paths is described in a distinct row of the PDAC table.

Particular fields of the row identify a path-starting node and a path-ending node, and other fields describe intervening nodes. The PDAC table has traditionally included seven fields (that is, seven cells in each row of the PDAC table) that describe the path as a whole, including PDAC, PAA, a path-starting node DSN_A_LOC, a path-ending node DSN_Z_LOC, IOF_A, IOF_Z, and CXR_TYPE. The PDAC table has also traditionally contained seventeen fields (that is, seventeen cells in each row of the PDAC table) for each intervening node of the path. From the PDAC table, the entire path, including all intervening nodes, can be understood.

Since different paths have different number of nodes, the rows of the PDAC table do not all have the same number of cells. If a path includes only two adjacent nodes, for example, then the row of the PDAC table that describes the path has only twenty-four non-empty cells (the seven cells that describe the path as a whole, and the seventeen cells for the segment connecting the path-starting node to the path-ending node). All remaining cells of the row are empty. On the other hand, if a path requires fifteen segments, then the row of the PDAC table describing the row would have two-hundred sixty-two non-empty cells (the seven cells that describe the path as a whole, and the seventeen cells for each of the fifteen segments connecting the path-starting node to the path-ending node).

The use of a PDAC table has several problems. First, the addition or removal of a single node can require the PDAC table as a whole to be reconstructed. If a new node is added to the network, then a large number of new paths passing through the new node become available, since each pair of nodes might be connectable via any number of paths passing through the new node; each such path requires a row to be added to the PDAC table. Similarly, if a node is removed from the network, even temporarily, then all paths through the node become unavailable, and many rows may need to be removed from the PDAC table. If the node that is removed from the network is later added to the network, then a large number of paths may need to be recalculated.

Second, each segment may be described in many cells of the PDAC table. Any segment that may be included in many paths is therefore described in cells of many rows of the PDAC table. When a segment is changed, for example, if a cable is replaced by a higher-capacity cable, then all rows containing a cell that describes the segment must be updated.

Third, a large amount of data that is included in the PDAC table is not necessary for finding the optimal path through the network (although it may be necessary for other purposes). Finding the optimal path through the network may require accessing a very large amount of data (the PDAC table) when only a few fields in each row are relevant. Similarly, the inclusion of empty cells in the PDAC table may waste memory. The present invention addresses some of the above-noted problems and provides a method and system for selecting an optimal path in a network.

### SUMMARY OF THE INVENTION

In accordance with one aspect of the present invention, a method provides a circuit from a first customer location to a second customer location. The method includes selecting a path-starting node from a network of nodes, and selecting a path-ending node from the network of nodes. The path-starting node is connectable to the first customer location, and the path-ending node is connectable to the second customer location. The method also includes selecting at least one subset of files from a database containing a set of files. Each file (of the set of files) containing segment data pertains to a segment that connects a pair of nodes within the network. Each of the at least one subset contains data pertaining to a path from the path-starting node to the path-ending node. If more than one subset of files is selected, selecting an optimal path corresponding to an optimal subset of files.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 is a flowchart depicting a method of providing a circuit from a first customer location to a second customer location, in accordance with an exemplary embodiment of the present invention.

FIG. 2 is a schematic representation of a computer-readable medium, in accordance with another embodiment of the present invention.

FIG. 3 is a schematic representation of a computer system, in accordance with yet another embodiment of the present invention.

### DETAILED DESCRIPTION OF THE INVENTION

In view of the above, the present invention through one or more of its various aspects and/or embodiments is presented to provide one or more advantages, such as those noted below.

Reference will now be made in detail to several exemplary embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, also described herein as exemplary embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims. It is to be understood and appreciated that the process steps and structures described herein do not cover a complete process flow nor to all elements and components that may be found in a complete product, apparatus, or system. The present invention may be practiced in conjunction with various construction techniques that are conventionally used in the art, and only so much of the commonly practiced process steps are included herein as are necessary or useful to provide an understanding of the present invention. The following description is therefore presented for illustrative purposes.

In one exemplary embodiment of the present invention, a method provides a circuit from a first customer location to a second customer location. The method comprises selecting a path-starting node from a network of nodes, such that the path-starting node is connectable to the first customer location. The method also comprises selecting a path-ending node from the network of nodes, such that the path-ending node is connectable to the second customer location. The method also comprises selecting at least one subset of files from a database containing a set of files. Each file of the set of files containing segment data pertains to a segment that connects a pair of nodes within the network. Each of the at least one subset contains data pertaining to a path from the path-starting node to the path-ending node. If more than one subset of files is selected, selecting an optimal path corresponding to an optimal subset of files.

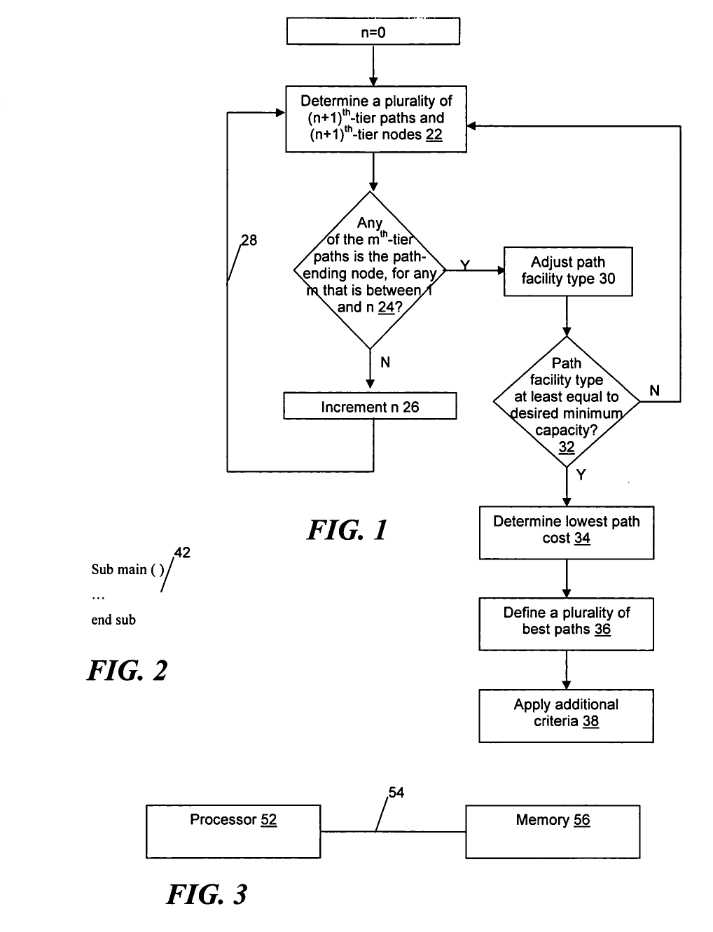

FIG. 1 is a flowchart depicting a method of providing a circuit from a first customer location to a second customer location, in accordance with the above-mentioned embodiment of the present invention. The network may include a large number of nodes, and is described in a plurality of segment files accessible through a database. Each segment file describes a segment, which may be a single hop, from one node to another node.

Each segment file, also called a TRIP file, may describe a first node and a second node, and may also describe a segment facility type. The first node and the second node that are described together within a segment file may be described as segment endpoints of the segment file, and may be said to be “adjacent.” Accordingly, each segment file describes a segment through the network from the first node to the second node, and from the second node to the first node. As segments are ordered, deployed, maintained, and deleted, corresponding segment files may be updated.

If a path-starting node has been selected, the database may include at least one segment file in which the path-starting node is a segment endpoint. Such a segment may be described as a 1st-tier segment, or a 1st-tier path, since each point 35 other than the path-starting node in such a segment file has a distance of one segment from the path-starting node. Each node having a distance of one segment from the path-starting node may be described as a 1st-tier node.

Accordingly, the method includes determining a plurality of 1st-tier paths and 1st-tier nodes 22, also referred to herein as a plurality of (n+1)th-tier paths and a plurality of (n+1)th-tier nodes, respectively, where n=0. The plurality of 1st-tier paths may be determined by searching the database for segment files that include the path-starting node as a segment endpoint. If at least one of the 1st-tier paths is the path-ending node, then a plurality of optimal paths is identified, and the plurality of optimal paths includes at least one of the 1st-tier paths. In general, however, it would be a rare situation in which the path-ending node is among the 1st-tier nodes.

If none of the 1st-tier paths is the path-ending node 24, then the method includes considering a next tier 26, including determining a plurality of 2nd-tier paths and a plurality of 2nd-tier nodes 26, also referred to herein as a plurality of (n+1)th-tier paths and a plurality of (n+1)th-tier nodes, respectively, where n=1. The plurality of 2nd-tier paths may be determined by searching the database for segment files that do not include the path-starting node but that do include any of the 1st-tier nodes as a segment endpoint. If at least one of the 2nd-tier paths is the path-ending node, then a plurality of optimal paths is identified, and the plurality of optimal paths includes at least one of the 2nd-tier paths.

If none of the 1st-tier paths and none of the 2nd-tier paths is the path-ending node, then the method continues iteratively 28. A plurality of (n+1)th-tier paths may be determined, for example, by searching the database for segment files that do not include the path-starting node and that do not include any of the mth-tier nodes, for any m that is between 1 and n, but that do include at least one of the (n+1)th-tier nodes as a segment endpoint. If at least one of the (n+1)th-tier paths is the path-ending node, then a plurality of optimal paths is identified, and the plurality of optimal paths includes at least one of the (n+1)th-tier paths. Each of the (n+1)th-tier nodes may be said to have a distance of n+1 segments from the path-starting node.

In other words, the method may continue, determining a plurality of paths each of which may have n+1 segments. Such paths may be described as (n+1)th-tier segments, and may be regarded as an nth-tier path (from the path-starting node to an nth-tier node) that is extended by one segment (from the nth-tier node to the (n+1)th-tier node). The nth-tier path may be a path that has n segments, from the path-starting node to an nth-tier node. The segment from the nth-tier node to the (n+1)th-tier node may be regarded as an (n+1)th segment.

A segment file, and thus a segment described by the segment file, may also contain a segment facility type. For example, a facility type of a segment may be defined as a data bandwidth, capacity, maximum data bit rate, or type of a cable between the endpoints of the segment.

Similarly, each path may have a path facility type, which may be adjusted 30 to be no greater than any segment facility type of any segment in the path. For example, if a path contains only two segments including a first segment having an OC48 fiberoptic cable and a second segment having an OC192 fiberoptic cable, then the path facility type may be defined as OC48, since OC48 is no greater than any segment facility type of any segment in the path; in such a situation, the path facility type may not be OC192, since OC192 is greater than the segment facility type of the first segment.

Accordingly, if a path does not have a path facility type but contains a segment that has a segment facility type, then a path facility type may be defined as equal to the segment facility type of the segment. For example, if a 1st-tier path is defined for a segment file that includes the path-starting node as a segment endpoint, if the segment file contains a segment facility type, then the 1st-tier path may be defined as equal to the segment facility type.

Furthermore, if a path that has a path facility type contains a segment that has a segment facility type, then the path facility type may be compared to the segment facility type. If the path facility type is greater than the segment facility type, the path facility type may be adjusted downward to become equal to the segment facility type. As each segment is added to a path, the path facility type may be adjusted downward, such that the path facility type is not greater than the segment facility type of any segment within the path.

If a desired minimum capacity has been specified, then any path that has a path facility type less than the desired minimum capacity may be excluded from the plurality of optimal paths 32. The plurality of optimal paths may be determined with the desired minimum capacity in mind.

A complete path may be described as a path that includes both the path-starting node and the path-ending node. Each complete path may have a path cost. A plurality of path costs may thus be determined, if at least one node of at least one path is the path-ending node. Each path cost may correspond to a path that includes both the path-starting node and the path-ending node.

The path cost of a path may be a count of the segments within the path. In other words, if the (n+1)th-tier of nodes includes the path-ending node, then the path cost may be “n+1.” The path cost may thus be determined by counting segments in each path, since the path cost of each path is equal to the number of segments in the path.

If one of the complete paths has a lowest path cost, then an optimal path may be described as the complete path that has the lowest path cost 34. If more than one of the complete paths have identical path costs, and if no other complete path has a lower path cost, then a plurality of optimal paths may be defined 36. The plurality of optimal paths may be determined such that no path (in the network, from the path-starting node to the path-ending node) has fewer segments than any optimal path in the plurality of optimal paths. If a minimum capacity has been specified (and signal splitting is not permitted), then the plurality of optimal paths may also be determined to exclude a complete path that has path facility type that is less than the minimum capacity.

If desired, all possible paths from the path-starting node to the path-ending node may be identified. On the other hand, identifying possible paths may conclude as soon as a path from the path-starting node to the path-ending node has been found.

If the plurality of optimal paths includes more than one optimal path, additional criteria may be applied to select a preferred optimal path 38. For example, if a plurality of physical circuits is available, and if the desired minimum capacity may be added to any of the plurality of physical circuits without deleterious effect, then additional criteria may be applied to select a preferred optimal path.

Additional criteria may include, for example, load aggregation. The plurality of physical circuits may be examined, and an a-priori load may be determined for each of the plurality of physical circuits. The preferred optimal path may then be determined to correspond to the physical circuit with the greatest a-priori load. Accordingly, each virtual circuit may be added to a physical circuit that already provides other virtual circuits. Some physical circuits may therefore have large loads while other physical circuits have little or no loads and can therefore be taken down and repaired. Concentrating as much traffic as possible onto as few physical circuits as possible may help reduce costs, since only a few high-capacity physical circuits need to be maintained.

Similarly, the plurality of physical circuits may be examined, and a-priori headroom may be determined for each of the plurality of physical circuits. The preferred optimal path may then be determined to correspond to the physical circuit with the greatest a-priori headroom. Accordingly, if a low-capacity cable and a high-capacity physical circuit are both available, the virtual circuit may be added to the high-capacity physical circuit. Concentrating as much traffic as possible onto newer physical circuits may be desirable.

Additional criteria may alternatively include, for example, load balancing. In other words, the plurality of physical circuits may be examined, and an a-priori load may be determined for each of the plurality of physical circuits. The preferred optimal path may then be determined to correspond to the physical circuit with the least an a-priori load. Distributing traffic as much as possible may provide greater redundancy, for example, in a packet-switched network where physical connections are unreliable. A load availability may be determined for each path in the plurality of optimal paths; and the optimal path may be selected as the path for which the load availability is least.

FIG. 2 is a schematic representation of a computer-readable medium, in accordance with another embodiment of the present invention. The computer readable medium contains a set of instructions 42 that, when executed by a computer, are operative to cause the computer to perform a method of selecting an optimal path from a path-starting node of a network to a path-ending node of the network. The network may include a large number of nodes, and is described in a plurality of segment files accessible through a database. Each segment file describes a segment from one node to another node. The segment may be a single hop.

The set of instructions 42 is operative to cause the computer to access a plurality of segment files, also called TRIP files, each of which may describe a first node and a second node and may also describe a segment facility type. The first node and the second node that are described together within a segment file may be described as segment endpoints of the segment file, and may be said to be “adjacent.” Accordingly, each segment file describes a segment through the network from the first node to the second node, and from the second node to the first node. As segments are ordered, deployed, maintained, and deleted, corresponding segment files may be updated.

The set of instructions 42 may also be operative to cause the computer to identify a plurality of 1st-tier paths. If a path-starting node has been selected, the database may include at least one segment file in which the path-starting node is a segment endpoint. Such a segment may be described as a 1st-tier segment, or a 1st-tier path, since each point other than the path-starting node in such a segment file has a distance of one segment from the path-starting node. Each node having a distance of one segment from the path-starting node may be described as a 1st-tier node.

Accordingly, the set of instructions 42 may be operative to cause the computer to determine a plurality of 1st-tier paths. The plurality of 1st-tier paths may be determined by searching the database for segment files that include the path-starting node as a segment endpoint.

The set of instructions 42 may also be operative to cause the computer to identify a plurality of 1st-tier nodes. If at least one of the 1st-tier paths is the path-ending node, then a plurality of optimal paths is identified, and the plurality of optimal paths includes at least one of the 1st-tier paths. In general, however, it would be a rare situation in which the path-ending node is among the 1st-tier nodes.

The set of instructions 42 may also be operative to cause the computer to determine whether any of the 1st-tier paths is the path-ending node. If none of the 1st-tier paths is the path-ending node, then the set of instructions 42 may be operative to cause the computer to determine a plurality of 2nd-tier paths and a plurality of 2nd-tier nodes, also described herein as (n+1)th-tier paths and (n+1)th-tier nodes, respectively, where (n=1). The plurality of 2nd-tier paths may be determined by searching the database for segment files that do not include the path-starting node but that do include any of the 1st-tier nodes as a segment endpoint. If at least one of the 2nd-tier nodes is the path-ending node, then a plurality of optimal paths is identified, and the plurality of optimal paths includes at least one of the 2nd-tier paths.

If none of the 1st-tier paths and none of the 2nd-tier paths is the path-ending node, then the set of instructions 42 may be operative to cause the computer to continue iteratively. A plurality of (n+1)th-tier paths may be determined, for example, by searching the database for segment files that do not include the path-starting node and that do not include any of the mth-tier nodes, for any m that is between 1 and n, but that do include at least one of the (n+1)th-tier nodes as a segment endpoint. If at least one of the (n+1)th-tier paths is the path-ending node, then a plurality of optimal paths is identified, and the plurality of optimal paths includes at least one of the (n+1)th-tier paths. Each of the (n+1)th-tier nodes may be said to have a distance of n+1 segments from the path-starting node.

In other words, the set of instructions 42 may be operative to cause the computer to determine a plurality of paths, each of which may have n+1 segments. Such paths may be described as (n+1)th-tier segments, and may be regarded as an nth-tier path (from the path-starting node to an nth-tier node) that is extended by one segment (from the nth-tier node to the (n+1)th-tier node). The nth-tier path may be a path that has n segments, from the path-starting node to an nth-tier node. The segment from the nth-tier node to the (n+1)th-tier node may be regarded as an (n+1)th segment.

A segment file, and thus a segment described by the segment file, may also contain a segment facility type. For example, a facility type of a segment may be defined as a data bandwidth, capacity, maximum data bit rate, or type of a cable between the endpoints of the segment.

The set of instructions 42 may also be operative to cause a computer to set, or adjust downward, a path facility type. Each path may have a path facility type, which may be adjusted to be no greater than any segment facility type of any segment in the path. For example, if a path contains only two segments including a first segment having an OC48 fiberoptic cable and a second segment having an OC192 fiberoptic cable, then the set of instructions 42 may be operative to cause the computer to set the path facility type to “OC48, ” since OC48 is no greater than any segment facility type of any segment in the path; in such a situation, the path facility type may not be OC192, since OC192 is greater than the segment facility type of the first segment.

The set of instructions 42 may also be operative to cause a computer to set a path facility type to be equal to the segment facility type of the segment, in response to a determination that a path does not have a path facility type but contains a segment that has a segment facility type. For example, if a 1st-tier path is defined for a segment file that includes the path-starting node as a segment endpoint, if the segment file contains a segment facility type, then the 1st-tier path may be defined as equal to the segment facility type.

Accordingly, if a path that has a path facility type contains a segment has a segment facility type, then the path facility type may be compared to the segment facility type. If the path facility type is greater than the segment facility type, the path facility type may be adjusted downward to become equal to the segment facility type.

As each segment is added to a path, the path facility type may be adjusted downward, such that the path facility type is not greater than the segment facility type of any segment within the path.

The set of instructions 42 also may be operative to cause a computer to exclude, from the plurality of optimal paths, any path that has a path facility type less than the desired minimum capacity, in response to a specification of a desired minimum capacity. The plurality of optimal paths may be determined with the desired minimum capacity in mind.

The set of instructions 42 may also be operative to cause the computer to determine a path cost for each complete path, where a complete path may be described as a path that includes both the path-starting node and the path-ending node. Each complete path may have a path cost, if at least one node of at least one path is the path-ending node. Each path cost may correspond to a path that includes both the path-starting node and the path-ending node.

The path cost of a path may be a count of the segments within the path. In other words, if the (n+1)th tier of nodes includes the path-ending node, then the path cost may be “n+1.” The path cost may thus be determined by counting segments in each path, since the path cost of each path is equal to the number of segments in the path.

If one of the complete paths has a lowest path cost, then an optimal path may be described as the complete path that has the lowest path cost. If more than one of the complete paths have identical path costs, and if no other complete path has a lower path cost, then a plurality of optimal paths may be defined. The plurality of optimal paths may be determined such that no path in the network from the path-starting node to the path-ending node has fewer segments than any optimal path in the plurality of optimal paths. If a minimum capacity has been specified (and signal splitting is not permitted), then the plurality of optimal paths may also be determined to exclude a complete path that has a path facility type that is less than the minimum capacity.

If desired, the set of instructions 42 may be operative to cause the computer to identify all possible paths from the path-starting node to the path-ending node. On the other hand, the set of instructions 42 may be operative to cause the computer to identify possible paths and may conclude as soon as a path from the path-starting node to the path-ending node has been found.

If the plurality of optimal paths includes more than one optimal path, the set of instructions 42 may be operative to cause the computer to apply additional criteria to select a preferred optimal path. For example, if a plurality of physical circuits is available, and if the desired minimum capacity may be added to any of the plurality of physical circuits without deleterious effect, then the set of instructions 42 may be operative to cause the computer to apply additional criteria to select a preferred optimal path.

Additional criteria may include, for example, load aggregation. The set of instructions 42 may be operative to cause the computer to examine the plurality of physical circuits, and to determine an a-priori load for each of the plurality of physical circuits. The set of instructions 42 may be operative to cause the computer to determine a preferred optimal path to correspond to the physical circuit with the greatest a-priori load. Accordingly, the set of instructions 42 may be operative to cause the computer to add each virtual circuit to a physical circuit that already provides other virtual circuits. Some physical circuits may therefore have large loads while other physical circuits have little or no loads and can therefore be taken down and repaired. Concentrating as much traffic as possible onto as few physical circuits as possible may help reduce costs, since only a few high-capacity physical circuits need be maintained.

Similarly, the set of instructions 42 may be operative to cause the computer to examine the plurality of physical circuits, and to determine an a-priori headroom for each of the plurality of physical circuits. The set of instructions 42 may be operative to cause the computer to determine a preferred optimal path to correspond to the physical circuit with the greatest a-priori headroom. Accordingly, if a low-capacity cable and a high-capacity physical circuit are both available, the set of instructions 42 may be operative to cause the computer to add the virtual circuit to the high-capacity physical circuit. Concentrating as much traffic as possible onto newer physical circuits may be desirable.

Additional criteria may alternatively include, for example, load balancing. In other words, the set of instructions 42 may be operative to cause the computer to examine the plurality of physical circuits, and to determine an a-priori load for each of the plurality of physical circuits. The set of instructions 42 may also be operative to cause the computer to determine the preferred optimal path to correspond to the physical circuit with the least a-priori load. Distributing traffic as much as possible may provide greater redundancy, for example, in a packet-switched network where physical connections are unreliable. The set of instructions 42 may be operative to cause the computer to determine a load availability of each path in the plurality of optimal paths; and the optimal path may be selected as the path for which the load availability is least.

FIG. 3 is a schematic representation of a computer-system, in accordance with yet another embodiment of the present invention. The computer system includes a processor 52, a bus 54 coupled to the processor 52, and a memory 56 coupled to the bus 54. The processor 52 may be any one or more logic gate, server-client process, or other intelligent device that may be used in or in conjunction with a computer system. The memory may be any mass storage device, hard drive, disk, RAM, ROM, EPROM, EEPROM, flash, or other device capable of storing information, either locally or remotely. The memory 56 contains a set of computer-readable instructions that, when executed by the processor 52, are operative to cause the processor 52 to perform a method of providing a circuit from a first customer location to a second customer location. The network may include a large number of nodes, and is described in a plurality of segment files accessible through a database. Each segment file describes a segment, which may be a single hop, from one node to another node.

The memory 56 may also contain a plurality of segment files, also called TRIP files, each of which may describe a first node and a second node and may also describe a segment facility type. The first node and the second node that are described together within a segment file may be described as segment endpoints of the segment file, and may be said to be “adjacent.” Accordingly, each segment file describes a segment through the network from the first node to the second node, and from the second node to the first node. As segments are ordered, deployed, maintained, and deleted, corresponding segment files may be updated.

In response to a path-starting node, the computer may be configured such that the processor 52 is operative to identify a plurality of 1st-tier paths. If a path-starting node has been selected, the database may include at least one segment file in which the path-starting node is a segment endpoint. Such a segment may be described as a 1st-tier segment, or a 1st-tier path, since each point other than the path-starting node in such a segment file has a distance of one segment from the path-starting node. Each node having a distance of one segment from the path-starting node may be described as a 1st-tier node.

Accordingly, the computer may be configured such that the processor 52 is operative to determine a plurality of 1st-tier paths. The plurality of 1st-tier paths may be determined by searching the database for segment files that include the path-starting node as a segment endpoint.

The set of instructions may also be operative to cause the processor 52 to identify a plurality of 1st-tier nodes. If at least one of the 1st-tier paths is the path-ending node, then a plurality of optimal paths is identified, and the plurality of optimal paths includes at least one of the 1st-tier paths. In general, however, it would be a rare situation in which the path-ending node is among the 1st-tier nodes.

The set of instructions may also be operative to cause the processor 52 to determine whether any of the 1st-tier paths is the path-ending node. If none of the 1st-tier paths is the path-ending node, then the computer may be configured such that the processor 52 is operative to determine a plurality of 2nd-tier paths and a plurality of 2nd-tier nodes, also described herein as (n+1)th-tier paths and (n+1)th-tier nodes, respectively, where (n=1). The plurality of 2nd-tier paths may be determined by searching the database for segment files that do not include the path-starting node but that do include any of the 1st-tier nodes as a segment endpoint. If at least one of the 2nd-tier nodes is the path-ending node, then a plurality of optimal paths is identified, and the plurality of optimal paths includes at least one of the 2nd-tier paths.

If none of the 1st-tier paths and none of the 2nd-tier paths is the path-ending node, then the computer may be configured such that the processor 52 is operative to continue iteratively. A plurality of (n+1)th-tier paths may be determined, for example, by searching the database for segment files that do not include the path-starting node and that do not include any of the mth-tier nodes, for any m that is between 1 and n, but that do include at least one of the (n+1)th-tier nodes as a segment endpoint. If at least one of the (n+1)th-tier paths is the path-ending node, then a plurality of optimal paths is identified, and the plurality of optimal paths includes at least one of the (n+1)th-tier paths. Each of the (n+1)th-tier nodes may be said to have a distance of n+1 segments from the path-starting node.

In other words, the set of instructions may be operative to cause the computer to determine a plurality of paths, each of which may have n+1 segments. Such paths may be described as (n+1)th-tier segments, and may be regarded as an nth-tier path (from the path-starting node to an nth-tier node) that is extended by one segment (from the nth-tier node to the (n+1)th-tier node). The nth-tier path may be a path that has n segments, from the path-starting node to an nth-tier node. The segment from the nth-tier node to the (n+1)th-tier node may be regarded as an (n+1)th segment.

A segment file, and thus a segment described by the segment file, may also contain a segment facility type. For example, a facility type of a segment may be defined as a data bandwidth, capacity, maximum data bit rate, or type of a cable between the endpoints of the segment.

The set of instructions may also be operative to cause the processor 52 to set, or adjust downward, a path facility type. Each path may have a path facility type, which may be adjusted to be no greater than any segment facility type of any segment in the path. For example, if a path contains only two segments including a first segment having an OC48 fiberoptic cable and a second segment having an OC192 fiberoptic cable, then set of instructions may be operative to cause the computer to set the path facility type to “OC48, ” since OC48 is no greater than any segment facility type of any segment in the path; in such a situation, the path facility type may not be OC192, since OC192 is greater than the segment facility type of the first segment.

The set of instructions may also be operative to cause the processor 52 to set a path facility type to be equal to the segment facility type of the segment, in response to a determination that a path does not have a path facility type but contains a segment that has a segment facility type. For example, if a 1st-tier path is defined for a segment file that includes the path-starting node as a segment endpoint, if the segment file contains a segment facility type, then the 1st-tier path may be defined as equal to the segment facility type.

Accordingly, if a path that has a path facility type contains a segment that has a segment facility type, then the path facility type may be compared to the segment facility type. If the path facility type is greater than the segment facility type, the path facility type may be adjusted downward to become equal to the segment facility type. As each segment is added to a path, the path facility type may be adjusted downward, such that the path facility type is not greater than the segment facility type of any segment within the path.

The set of instructions also may be operative to cause the processor 52 to exclude, from the plurality of optimal paths, any path that has a path facility type less than the desired minimum capacity, in response to a specification of a desired minimum capacity. The plurality of optimal paths may be determined with the desired minimum capacity in mind.

The set of instructions may also be operative to cause the processor 52 to determine a path cost for each complete path, where a complete path may be described as a path that includes both the path-starting node and the path-ending node. Each complete path may have a path cost, if at least one node of at least one path is the path-ending node. Each path cost may correspond to a path that includes both the path-starting node and the path-ending node.

The path cost of a path may be a count of the segments within the path. In other words, if the (n+1)th tier of nodes includes the path-ending node, then the path cost may be “n+1.” The path cost may thus be determined by counting segments in each path, since the path cost of each path is equal to the number of segments in the path.

If one of the complete paths has a lowest path cost, then an optimal path may be described as the complete path that has the lowest path cost. If more than one of the complete paths have identical path costs, and if no other complete path has a lower path cost, then a plurality of optimal paths may be defined. The plurality of optimal paths may be determined such that no path in the network from the path-starting node to the path-ending node has fewer segments than any optimal path in the plurality of optimal paths. If a minimum capacity has been specified (and signal splitting is not permitted), then the plurality of optimal paths may also be determined to exclude a complete path that has path facility type that is less than the minimum capacity.

If desired, the computer may be configured such that the processor 52 is operative to identify all possible paths from the path-starting node to the path-ending node. On the other hand, the computer may be configured such that the processor 52 is operative to identify possible paths and may conclude as soon as a path from the path-starting node to the path-ending node has been found.

If the plurality of optimal paths includes more than one optimal path, the computer may be configured such that the processor 52 is operative to apply additional criteria to select a preferred optimal path. For example, if a plurality of physical circuits is available, and if the desired minimum capacity may be added to any of the plurality of physical circuits without deleterious effect, then the computer may be configured such that the processor 52 is operative to apply additional criteria to select a preferred optimal path.

Additional criteria may include, for example, load aggregation. The computer may be configured such that the processor 52 is operative to examine the plurality of physical circuits, and to determine an a-priori load for each of the plurality of physical circuits. The computer may be configured such that the processor 52 is operative to determine a preferred optimal path to correspond to the physical circuit with the greatest a-priori load. Accordingly, the computer may be configured such that the processor 52 is operative to add each virtual circuit to a physical circuit that already provides other virtual circuits. Some physical circuits may therefore have large loads while other physical circuits have little or no loads and can therefore be taken down and repaired. Concentrating as much traffic as possible onto as few physical circuits as possible may help reduce costs, since only a few high-capacity physical circuits need be maintained.

Similarly, the computer may be configured such that the processor 52 is operative to examine the plurality of physical circuits, and to determine a-priori headroom for each of the plurality of physical circuits. The computer may be configured such that the processor 52 is operative to determine a preferred optimal path to correspond to the physical circuit with the greatest a-priori headroom. Accordingly, if a low-capacity cable and a high-capacity physical circuit are both available, the computer may be configured such that the processor 52 is operative to add the virtual circuit to the high-capacity physical circuit. Concentrating as much traffic as possible onto newer physical circuits may be desirable.

Additional criteria may alternatively include, for example, load balancing. In other words, the computer may be configured such that the processor 52 is operative to examine the plurality of physical circuits, and to determine an a-priori load for each of the plurality of physical circuits. The set of instructions may also be operative to cause the processor 52 to determine the preferred optimal path to correspond to the physical circuit with the least a-priori load. Distributing traffic as much as possible may provide greater redundancy, for example, in a packet-switched network where physical connections are unreliable. The computer may be configured such that the processor 52 is operative to determine a load availability of each path in the plurality of optimal paths; and the optimal path may be selected as the path for which the load availability is least.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method of providing a circuit from a first customer location to a second customer location, the method comprising:
selecting (a) a path-starting node that is connectable to the first customer location, and (b) a path-ending node that is connectable to the second customer location from a database containing a set of files, each file of the set of files containing segment data pertaining to a segment that connects a pair of nodes within the network, selecting at least one subset of files, such that each of the at least one subset contains data pertaining to a path from the path-starting node to the path-ending node; and if more than one subset of files is selected, selecting an optimal path corresponding to an optimal subset of files.

2. The method of claim 1, wherein selecting at least one subset of files includes:
(a) determining a plurality of 1st-tier paths such that each 1st-tier path of the plurality of 1st-tier paths is a 1st-tier segment from the path-starting node to a 1st-tier node adjacent to the path-starting node within the network, the 1st-tier segment being of a database of segments, each of the 1st-tier nodes having a distance of one segment from the path-starting node;
(b) identifying a plurality of (n+1)^{th}-tier nodes, each of the (n+1)^{th}-tier nodes having a distance of n+1 segments from the path-starting node if none of the(n+1)^{th}-tier nodes is the path ending node;
determining a plurality of paths each of which has n+1 segments and includes (i) a path that has n segments, from the path-starting node to an nth-tier node and (ii) an (n+1)^{th} segment from the n^{th}-tier node to an (n+1)^{th}-tier node adjacent to the n^{th}-tier node within the network, the (n+1)^{th}-tier segment being of the database of segments;
(c) determining a plurality of path costs, each path cost of the plurality of path costs corresponding to a path that includes both the path-starting node and the path-ending node if at least one node of at least one path is the path-ending node;
(d) determining a plurality of optimal paths from the plurality of path costs

3. The method of claim 2, further comprising:
counting segments in each path, wherein the path cost of each path is equal to a number of segments in the path, wherein the plurality of optimal paths is determined such that no path in the network from the path-starting node to the path-ending node has fewer segments than any optimal path in the plurality of optimal paths.

4. The method of providing a circuit from a first customer location to a second customer location of claim 2, further comprising:
excluding from the plurality of optimal paths any path that has a path facility type less than a desired minimum capacity, including:
for each segment that has a segment facility type and that is included in a path lacking a path facility type, setting the path facility type to the segment facility type; and
for each segment that has a segment facility type and that is included in a path having a path facility type, re-setting the path facility type to the segment facility type if the path facility type is greater than the segment facility type;
excluding from the plurality of optimal paths any path that has a path facility type less than the desired minimum capacity.

5. The method of claim 4, wherein:
the database includes a TRIP file for each segment, the TRIP file including a first node and a second node.

6. The method of claim 5, wherein:
the TRIP file further includes a segment facility type.

7. The method of claim 4, further comprising:
aggregating loads, including:
determining a load availability of each path in the plurality of optimal paths; and
selecting as the optimal path the path for which the load availability is greatest.

8. The method of providing a circuit from a first customer location to a second customer location of claim 4, further comprising:
balancing loads, including:
determining a load availability of each path in the plurality of optimal paths; and
selecting as the optimal path the path for which the load availability is least.

9. A computer-readable medium containing a set of instructions that when executed by a computer cause the computer to execute a method, the method including selecting:
(a) a path-starting node that is connectable to the first customer location, and
(b) a path-ending node that is connectable to the second customer location, the path starting node and the path-ending node being of a network of nodes; and
selecting at least one subset of files from a database containing a set of files, such that:
each file of the set of files contains segment data pertaining to a segment that connects a pair of nodes within the network,
each of the at least one subset contains data pertaining to a path from the path-starting node to the path-ending node; and
selecting an optimal path corresponding to an optimal subset of files, if more than one subset of files is selected.

10. A computer-readable medium of claim 9, wherein selecting a subset of files includes:
(a) determining a plurality of 1st-tier paths such that each 1st-tier path of the plurality of 1st-tier paths is a 1st-tier segment from the path-starting node to a 1st-tier node adjacent to the path-starting node within the network, the 1st-tier segment being of a database of segments, each of the 1st-tier nodes having a distance of one segment from the path-starting node;
(b) while none of the n^{th}-tier nodes is the path-ending node,
identifying a plurality of (n+1)^{th}-tier nodes, each of the (n+1)^{th}-tier nodes having a distance of n+1 segments from the path-starting node;
determining a plurality of paths each of which has n+1 segments and includes (i) a path that has n segments, from the path-starting node to an n^{th}-tier node and (ii) an (n+1)^{th} segment from the n^{th}-tier node to an (n+1)^{th}-tier node adjacent to the n^{th}-tier node within the network, the (n+1)^{th}-tier segment being of the database of segments;
(c) if at least one node of at least one path is the path-ending node, determining a plurality of path costs, each path cost of the plurality of path costs corresponding to a path that includes both the path-starting node and the path-ending node;
(d) from the plurality of path costs, determining a plurality of optimal paths.

11. The computer-readable medium of claim 11, wherein the set of instructions also includes at least one instruction for:
counting segments in each path, wherein the path cost of each path is equal to a number of segments in the path, wherein the plurality of optimal paths is determined such that no path in the network from the path-starting node to the path-ending node has fewer segments than any optimal path in the plurality of optimal paths.

12. The computer-readable medium of claim 11, wherein the set of instructions also includes at least one instruction for:
excluding from the plurality of optimal paths any path that has a path facility type less than a desired minimum capacity, including:
for each segment that has a segment facility type and that is included in a path lacking a path facility type, setting the path facility type to the segment facility type; and
for each segment that has a segment facility type and that is included in a path having a path facility type, re-setting the path facility type to the segment facility type if the path facility type is greater than the segment facility type;
excluding from the plurality of optimal paths any path that has a path facility type less than the desired minimum capacity.

13. The computer-readable medium of selecting claim 13, wherein:
the database includes a TRIP file for each segment, the TRIP file including a first node and a second node.

14. The computer-readable medium of claim 14, wherein:
the TRIP file further includes a segment facility type.

15. The computer-readable medium of claim 13, wherein the set of instructions also includes at least one instruction for:
aggregating loads, including:
determining a load availability of each path in the plurality of optimal paths; and
selecting as the optimal path the path for which the load availability is greatest.

16. The computer-readable medium of selecting of claim 13, wherein the set of instructions also includes at least one instruction for:
balancing loads, including:
determining a load availability of each path in the plurality of optimal paths; and
selecting as the optimal path the path for which the load availability is least.

17. In a network of nodes in a telecommunications environment, a computer system comprising:
a processor;
a bus coupled to the processor; and
a memory coupled to the bus, the memory containing a set of instructions that when executed by a computer cause the computer to execute a method, the method including selecting:
(a) a path-starting node that is connectable to the first customer location, and
(b) a path-ending node that is connectable to the second customer location, the path-starting node and the path-ending node being of a network of nodes; and
selecting at least one subset of files from a database containing a set of files, such that:
each file of the set of files contains segment data pertaining to a segment that connects a pair of nodes within the network,
each of the at least one subset contains data pertaining to a path from the path-starting node to the path-ending node; and
selecting an optimal path corresponding to an optimal subset of files, if more than one subset of files is selected.

18. The computer system of claim 17, wherein
selecting at least one subset of files from the database containing the set of files includes:
(a) determining a plurality of 1st-tier paths such that each 1st-tier path of the plurality of 1st-tier paths is a 1st-tier segment from the path-starting node to a 1st-tier node adjacent to the path-starting node within the network, the 1st-tier segment being of a database of segments, each of the 1st-tier nodes having a distance of one segment from the path-starting node;
(b) while none of the n^{th}-tier nodes is the path-ending node,
identifying a plurality of (n+1)^{th}-tier nodes, each of the (n+1)^{th}-tier nodes having a distance of n+1 segments from the path-starting node;
determining a plurality of paths each of which has n+1 segments and includes (i) a path that has n segments, from the path-starting node to an n^{th}-tier node and (ii) an (n+1)^{th} segment from the n^{th}-tier node to an (n+1)^{th}-tier node adjacent to the nth-tier node within the network, the (n+1)^{th}-tier segment being of the database of segments;
(c) if at least one node of at least one path is the path-ending node, determining a plurality of path costs, each path cost of the plurality of path costs corresponding to a path that includes both the path-starting node and the path-ending node;
(d) from the plurality of path costs, determining a plurality of optimal paths.

19. The computer system of claim 18, wherein the set of instructions also includes at least one instruction for:
counting segments in each path, wherein the path cost of each path is equal to a number of segments in the path, wherein the plurality of optimal paths is determined such that no path in the network from the path-starting node to the path-ending node has fewer segments than any optimal path in the plurality of optimal paths.

20. The computer system of claim 18, wherein the set of instructions also includes at least one instruction for:
excluding from the plurality of optimal paths any path that has a path facility type less than a desired minimum capacity, including:
for each segment that has a segment facility type and that is included in a path lacking a path facility type, setting the path facility type to the segment facility type; and
for each segment that has a segment facility type and that is included in a path having a path facility type, re-setting the path facility type to the segment facility type if the path facility type is greater than the segment facility type;
excluding from the plurality of optimal paths any path that has a path facility type less than the desired minimum capacity.

21. The computer system of claim 21, wherein:
the database includes a TRIP file for each segment, the TRIP file including a first node and a second node.

22. The computer system of claim 22, wherein:
the TRIP file further includes a segment facility type.

23. The computer system of claim 21, wherein the set of instructions also includes at least one instruction for:
aggregating loads, including:
determining a load availability of each path in the plurality of optimal paths; and
selecting as the optimal path the path for which the load availability is greatest.

24. The computer system of claim 21, wherein the set of instructions also includes at least one instruction for:
balancing loads, including
determining a load availability of each path in the plurality of optimal paths; and
selecting as the optimal path the path for which the load availability is least.

25. A method of selecting an optimal path that in a telecommunication network that includes a plurality nodes that are linked by a segment to at least one adjacent node in the network, the method comprising:
(a) defining a path starting node that is connectable to a first location
(b) defining a path ending node that is connectable to a second location spaced from the first location;
(c) providing a database that includes the plurality of nodes and information relating to at least one characteristic of the each segment; and
(d) determining from the database using a computer available paths that link the starting node and the ending node in the network, and
(f) selecting an optimal path from the available paths based on a predefined criteria.

26. The method of 25 further comprising establishing a telecommunication link between the first and second locations utilizing the selected optimal path.

27. The method of claim 26 wherein the at least one characteristic includes at least one of: (i) load capacity; (ii) bandwidth; (iii) link type.

28. The method of claim 25 wherein the database includes A TRIP file for each segment, the trip file including a first node and a second node.
